(19) United States
(12) Patent Application Publication
(10) Pub. No.: US 2026/0030083 A1
(43) Pub. Date: Jan. 29, 2026

(54) SYSTEMS AND METHODS FOR ENHANCING MEMORY CODE RELIABILITY

(71) Applicant: Micron Technology, Inc., Boise, ID (US)

(72) Inventors: Vipul Patel, Santa Clara, CA (US); Theodore T. Pekny, San Jose, CA (US)

(73) Assignee: Micron Technology, Inc., Boise, ID (US)

(21) Appl. No.: 19/274,339

(22) Filed: Jul. 18, 2025

Related U.S. Application Data
(60) Provisional application No. 63/676,142, filed on Jul. 26, 2024.

(51) Int. Cl. G06F 11/00

(52) U.S. Cl. CPC G06F 11/008

(57) ABSTRACT

Methods, systems, and devices for techniques for enhancing memory code reliability are provided. A memory device includes an array of memory cells; a page buffer; a controller; a read-only memory (ROM) configured to store read-only data for performing one or more memory operations; and a first replacement memory (REM) configured store a first replacement data. The first REM is accessible by the controller via at least one of the array of memory cells and the page buffer. The device further includes a second REM configured to store a second replacement data for replacing at least one of the read-only data stored in the ROM or the first replacement data stored in the first REM. The controller is configured to access the second REM while bypassing the page buffer and the array of memory cells.

### CROSS-REFERENCE TO RELATED APPLICATION

This application claims priority to U.S. Provisional Application No. 63/676,142, filed on Jul. 26, 2024, entitled “SYSTEMS AND METHODS FOR ENHANCING MEMORY CODE RELIABILITY,” the content of which is incorporated by reference in its entirety for all purposes.

### TECHNICAL FIELD

This disclosure relates to one or more systems for memory, including techniques for improving code reliability for memory operations.

### BACKGROUND

Memory devices are widely used to store information in computers, user devices, wireless communication devices, cameras, digital displays, and others electronic devices. Information is typically stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine, etc.) states from the memory cells. To store information, the memory device may write (e.g., program, set, assign, etc.) states to the memory cells. Information can also be erased from the memory cells and new information can be stored in the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 is a block diagram of a memory device in communication with a memory system controller of a memory system, in accordance with examples as disclosed herein.

FIGS. 2A-2B are illustrative schematics of portions of an array of memory cells in a memory device, in accordance with examples as disclosed herein.

FIG. 3 is a block diagram of an example apparatus for implementing one or more systems and for performing one or more methods described herein, in accordance with examples as disclosed herein.

FIG. 4A illustrates a prior art device configured for replacing codes in a read-only memory (ROM).

FIG. 4B illustrates an example flowchart of device initialization using a prior art device shown in FIG. 4A.

FIG. 5 illustrates a memory device for replacing codes in a ROM with enhanced reliability and flexibility, in accordance with examples as disclosed herein.

FIG. 6 is a flowchart illustrating an initialization process of a memory device, in accordance with examples as disclosed herein.

FIG. 7 illustrates flowcharts showing a method or methods that support techniques for priority determination between first and second replacement memories (REMs), in accordance with examples as disclosed herein.

FIG. 8 is a flowchart illustrating a method for replacing codes stored in ROM using multiple REMs, in accordance with examples as disclosed herein.

### DETAILED DESCRIPTION

A memory device often includes a read-only memory (ROM), which stores executable codes for algorithms used to perform various important operations of the memory device. For example, the ROM can store codes for performing operations such as device initialization, read, program, erase, and other functions. The ROM is read-only and therefore cannot be re-written or otherwise changed after the memory device is manufactured. The codes stored in ROM are typically read and executed by a controller (e.g., a memory system controller or a local controller in the memory device). Firmware of the memory system or device may control the loading of these codes from the ROM to the controller.

To be more flexible, a memory device may also have a replacement memory (REM) used to replace particular portions of the codes stored in the ROM. For example, after the memory device is manufactured, errors may be found in the codes stored in ROM. As another example, one or more algorithms for operating the memory device may be updated after the memory device is manufactured. Therefore, some of the codes stored in the ROM may need to be replaced. Replacement codes, however, cannot be directly re-written into the ROM. Instead, a replacement memory (REM) may be used to receive and store the replacement codes. A REM may have a size of about 10-15% of the size of the ROM, and can be used to store codes for replacing certain portions of the ROM. Typically, after the controller executes the initialization codes stored in the ROM, it executes the codes for loading the replacement data stored in the REM. The replacement data include one or more particular ROM addresses and corresponding replacement codes. Accordingly, the controller replaces the codes stored at the particular ROM addresses with the replacement codes stored in the REM. In other words, the codes stored at the particular ROM addresses are not used, and the controller executes the replacement codes stored in the REM instead.

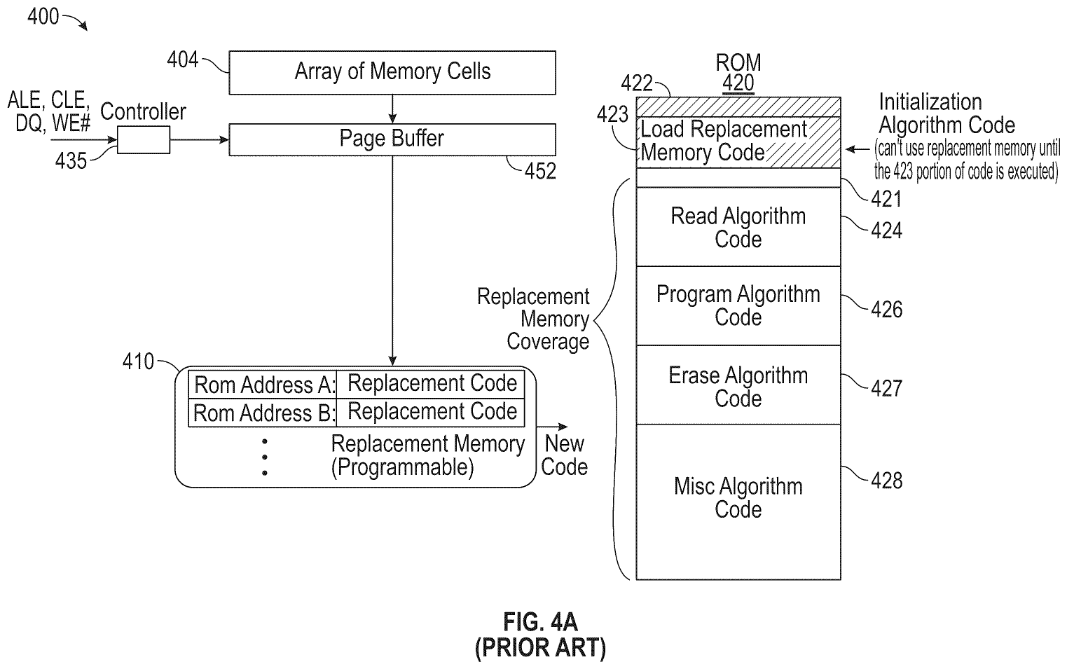

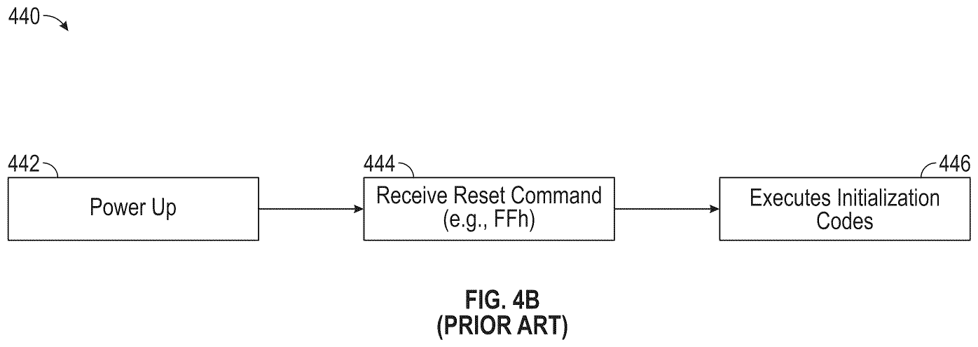

Writing replacement data to the REM, however, may not be performed by anyone at any time. Often times, it may only be performed by the memory device manufacturer before the device is shipped to the customer. Once the device is shipped to the customer, it is very difficult to replace codes stored in the ROM by using the REM. This is because special equipment and/or software may be required and therefore, the customer may not easily perform the code replacing process that can be performed by the memory device manufacturer. This inflexibility may cause a costly recall or even discarding of the memory device entirely. In some situations, even if the errors in the codes stored in ROM are found before the memory device is shipped to customers, the memory device may sometimes still need to be discarded, and replaced with a new memory device with updated codes stored in the ROM. For example, if the error code is in the 422 or 423 portion of the initialization code in ROM as shown below in FIG. 4A.

Devices and methods described in this disclosure provide enhanced flexibility and reliability for replacing codes stored in the ROM, by using multiple REMs while bypassing the page buffer. Using the techniques described herein, the read-only data stored in ROM can be easily replaced using a combination of a first REM and a second REM, before or after the memory device is manufactured and even after the device is shipped to customers. Accordingly, the code reliability and flexibility of the memory device can be greatly improved. Moreover, the size of the second REM can be configured to be much smaller than the first REM; and the second REM can be directly accessible by a controller while bypassing the page buffer. As a result, the accessing speed of the second REM can be fast. In turn, loading and updating the second REM with new or updated replacement codes can be performed quickly, resulting in significant improvements of efficiency. Details of the technologies are described below.

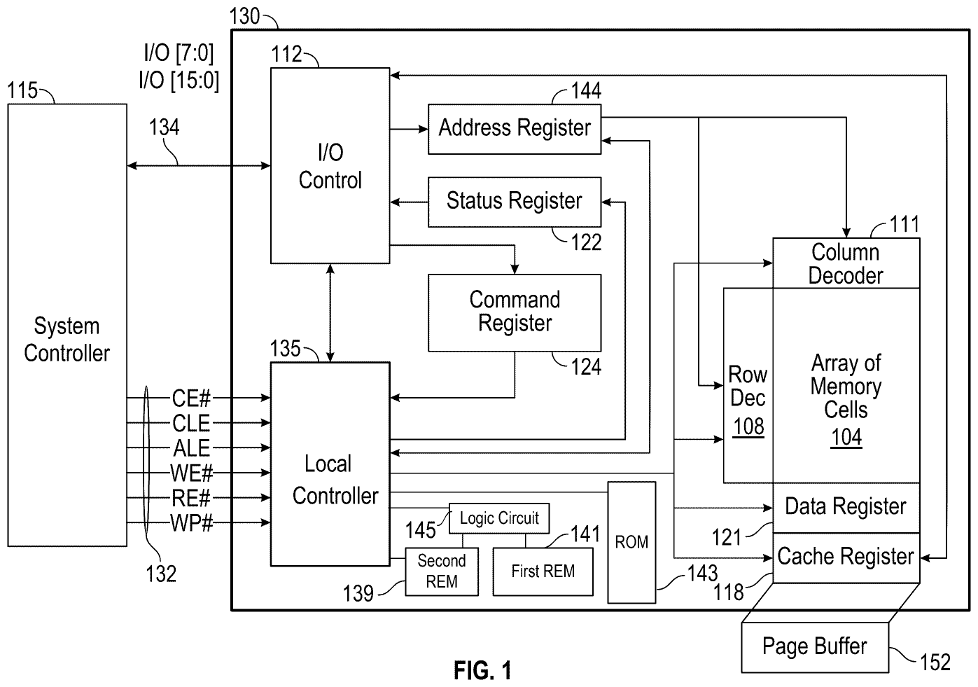

FIG. 1 is a simplified block diagram of a memory device 130 in communication with a system controller 115 of a memory system. A memory system may be or include any device or collection of devices, where the device or collection of devices includes at least one memory array. For example, a memory system may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices. A memory system may communicate with a host system, which may include a host system controller. The host system may be implemented using one or more processors and a memory system for writing data to the memory system, reading data from the memory system, erasing data, or refreshing data.

A memory system may include one or more memory devices, such as device 130. A memory device 130 may include one or more memory arrays of any type of memory cells (e.g., non-volatile memory cells, volatile memory cells, or any combination thereof). For example, memory device 130 may include NAND (e.g., NAND flash) memory, ROM, phase change memory (PCM), NOR (e.g., NOR flash) memory, etc. In some cases, memory device 130 is a NAND memory device 130, may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

As shown in FIG. 1 and described below in more detail, memory device 130 includes an array of memory cells 104 logically arranged in rows and columns. Memory cells of a logical row are typically connected to the same access line (e.g., a word line) while memory cells of a logical column are typically selectively connected to the same data line (e.g., a bit line). A single access line can be associated with more than one logical row of memory cells and a single data line can be associated with more than one logical column. Memory cells (not shown in FIG. 1) of at least a portion of the array of memory cells 104 are capable of being programmed to one of at least two target data states for storing any number of bits of information.

With continued reference to FIG. 1, row decode circuitry 108 and column decode circuitry 111 are provided to decode address signals. Address signals are received and decoded to access the array of memory cells 104. Memory device 130 also includes input/output (I/O) control circuitry 112 to manage input of commands, addresses, and data to memory device 130 as well as output of data and status information from memory device 130. An address register 114 is in communication with I/O control circuitry 112 and row decode circuitry 108 and column decode circuitry 111 to latch the address signals prior to decoding. Row decode circuitry 108 and column decode circuitry 111 may simply be referred to as row decoder 108 and column decoder 111, respectively. A command register 124 is in communication with the I/O control circuitry 112 and local controller 135 to latch incoming commands.

A memory controller (e.g., the local controller 135 internal to memory device 130) controls access to the array of memory cells 104 in response to the commands and generates status information for the external system controller 115. For instance, the local controller 135 is configured to perform access operations (e.g., read operations, programming operations, and/or erase operations) on the array of memory cells 104. The local controller 135 is in communication with row decode circuitry 108 and column decode circuitry 111 to control the row decode circuitry 108 and column decode circuitry 111 according to the addresses. In some examples, a memory controller (e.g., local controller 135 and/or system controller 115) may also load executable codes stored in a ROM 143 for performing various operations such as device initialization, read, programming, erase, or other operations. The data stored in ROM 143 are referred to as the read-only data, and typically cannot be changed after the memory device is manufactured. As described in greater detail below, in some examples, the memory controller may use a first replacement memory (REM) 141 and a second REM 139 for storing replacement data used to replacing certain read-only data stored at certain portions of the ROM. Logic circuit 145 may include detection logic circuit and priority determination logic circuit. Logic circuit 145 may be used in combination with the first REM 141 and second REM 139 for replacing the read-only data stored in the ROM 143. When replacing the read-only data stored in the ROM 143, the memory controller (e.g., controller 135 or 115) uses the replacement data stored in the first REM 141 or the second REM 139, instead of the read-only data stored in certain portions of the ROM 143. Logic circuit 145, first REM 141, second REM 139, and ROM 143 are described in greater detail below. Using the techniques described herein, the read-only data stored in ROM can be easily replaced using a combination of the first REM 141 and second REM 139, before or after the memory device is manufactured and even after the device is shipped to customers. Accordingly, the code reliability and flexibility of the memory device can be greatly improved.

Continuing with FIG. 1, in some embodiments, local controller 135 communicates with the external system controller 115, which may be a host controller (e.g., an UFS or eMMC controller, or a CPU communicating with local controller 135) located in a host system or a memory system controller located in a memory system. In some embodiments, local controller 135 is disposed on the same semiconductor die as the memory array (e.g., array 104), and a separate system controller 115 is disposed on a different die. In other examples, some portions of memory device 130 may be disposed on a first die and other portions of memory device 130 may be disposed on a second die different from the first die. For instance, the first die may include the array of memory cells 104 and its associated circuitry such as the column decoder 111 and row decoder 108, etc. The second die may include logic circuitry, power circuitry, or other circuitry of device 130. Thus, the second die may include system controller 115, I/O control 112, etc. In this example, the first die has no local controller, and the second die includes the system controller 115. The first die and the second die can be hybrid bonded together using, for example, through-hole vias (TSVs) such that they are electrically connected. The first die and the second die may also be wafer-bonded using flip-chip bonding technologies, etc. In this disclosure, a system controller 115 and a local controller 135 may both be referred to as memory controllers, or a first memory controller and a second memory controller, for simplicity. It is understood that while they may be different controllers, certain operations disclosed herein may be caused or performed by either or both memory controllers, unless otherwise specified.

Local controller 135 is also in communication with a cache register 118 and a data register 121. In some embodiments, one or more cache registers 118 can collectively form at least a part of a cache buffer. Cache register 118 latches or buffers data, either incoming or outgoing, as directed by local controller 135 to temporarily store data while the array of memory cells 104 is busy writing or reading, respectively, other data. During a program operation (e.g., write operation), data can be passed from cache register 118 to the data register 121 for transfer to the array of memory cells 104; then new data can be latched in cache register 118 from the I/O control circuitry 112. During a read operation, data can be passed from the cache register 118 to the I/O control circuitry 112 for output to the system controller 115; then new data can be passed from the data register 121 to cache register 118. In some embodiments, cache register 118 and/or the data register 121 can form at least a portion of a page buffer 152 of the memory device 130. The page buffer 152 can further include sensing devices such as a sense amplifier, to sense a data state of a memory cell of the array of memory cells 104, e.g., by sensing a state of a data line connected to that memory cell. A status register 122 can be in communication with I/O control circuitry 112 and the local memory controller 135 to latch the status information for output to system controller 115.

As shown in FIG. 1, memory device 130 receives various control signals via local controller 135 from system controller 115 over a control link 132. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) can be further received over control link 132 depending upon the nature of memory device 130. In one embodiment, memory device 130 receives command signals (which represent commands), address signals (which represent addresses), and data signals (which represent data) from the system controller 115 over a multiplexed input/output (I/O) bus 134 and outputs data to the system controller 115 over I/O bus 134.

For example, the commands can be received over input/output (I/O) pins [7:0] of I/O bus 134 at I/O control circuitry 112 and can then be written into a command register 124. The addresses can be received over input/output (I/O) pins [7:0] of I/O bus 134 at I/O control circuitry 112 and can then be written into address register 114. The data can be received over input/output (I/O) pins [7:0] for an 8-bit device or input/output (I/O) pins [15:0] for a 16-bit device at I/O control circuitry 112 and then can be written into cache register 118. The data can be subsequently written into data register 121 for programming the array of memory cells 104.

In an embodiment, cache register 118 can be omitted, and the data can be written directly into data register 121. Data can also be output over input/output (I/O) pins [7:0] for an 8-bit device or input/output (I/O) pins [15:0] for a 16-bit device. Although reference can be made to I/O pins, they can include any conductive node providing for electrical connection to the memory device 130 by an external device (e.g., the system controller 115), such as conductive pads or conductive bumps as are commonly used. While the above description using 16 bits I/O bus 134 as an example, it is understood that bus 134 can be configured to any number of bits (e.g., 64 bits).

It will be appreciated by those skilled in the art that additional circuitry and signals can be provided, and that memory device 130 of FIG. 1 has been simplified. It should be recognized that the functionality of the various block components described with reference to FIG. 1 may not necessarily be segregated to distinct components or component portions of an integrated circuit device. For example, a single component or component portion of an integrated circuit device could be adapted to perform the functionality of more than one block component of FIG. 1. Alternatively, one or more components or component portions of an integrated circuit device could be combined to perform the functionality of a single block component of FIG. 1. Additionally, while specific I/O pins are described in accordance with popular conventions for receipt and output of the various signals, it is noted that other combinations or numbers of I/O pins (or other I/O node structures) can be used in the various embodiments.

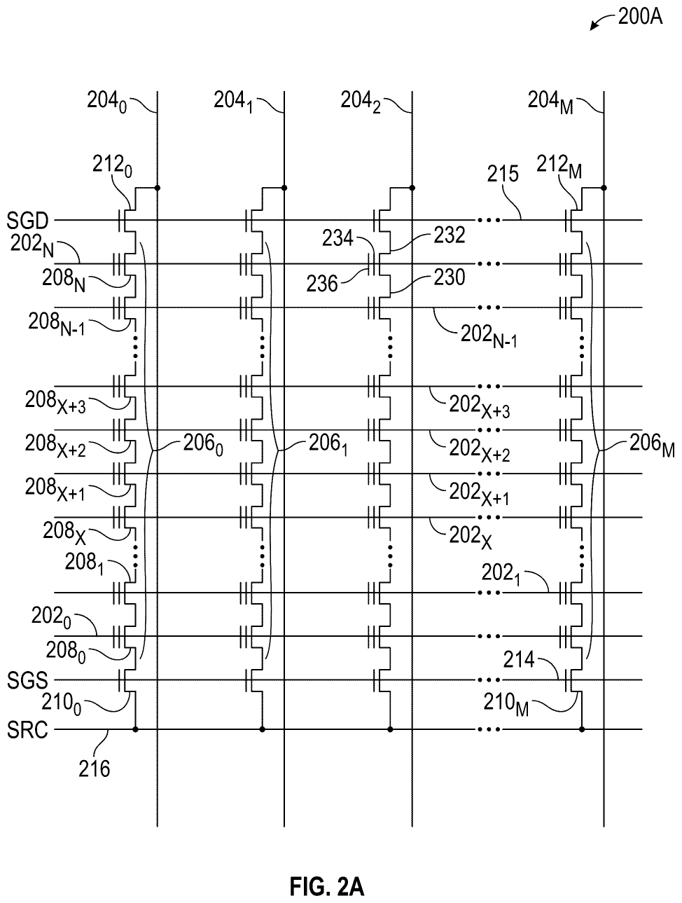

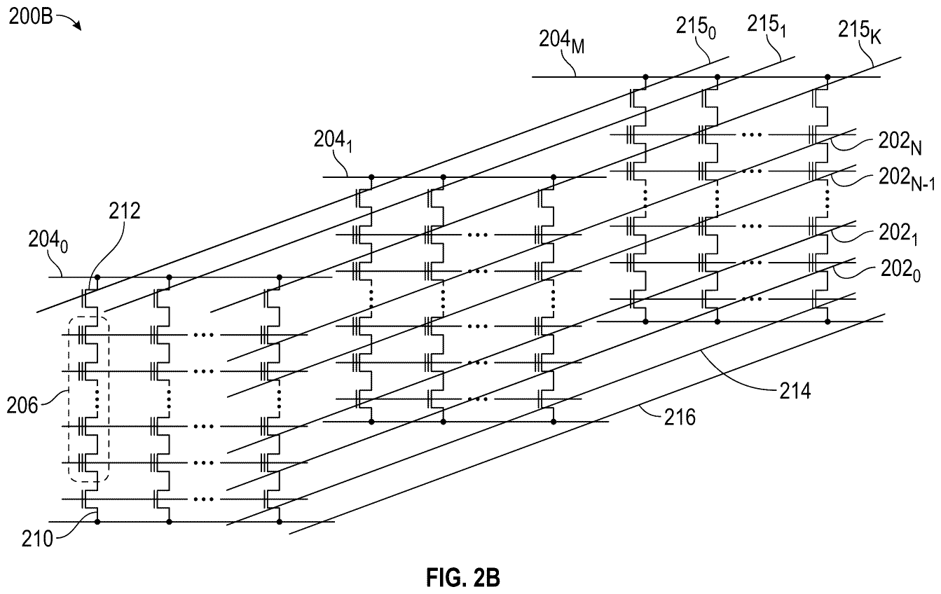

FIG. 2A-2B are example schematics of portions of an array of memory cells 200A, such as a NAND memory array. Array of memory cells 200A may be an example of memory array 104 of a memory device 130 as described with reference to FIG. 1 according to an embodiment. Memory array 200A includes access lines, such as word lines 202₀ to 202_{N}, and data lines, such as bit lines 204₀ to 204_{M}. The word lines 202 can be connected to global access lines (e.g., global word lines), not shown in FIG. 2A, in a many-to-one relationship. For some embodiments, memory array 200A can be formed over a semiconductor that, for example, can be doped to have a conductive type, such as a p-type conductivity, e.g., to form a p-well, or an n-type conductivity, e.g., to form an n-well.

Memory array 200A can be arranged in rows (each corresponding to a word line 202) and columns (each corresponding to a bit line 204). Each column can include a string of series-connected memory cells (e.g., non-volatile memory cells), such as one of NAND strings 206₀ to 206_{M}. Each NAND string 206 can be connected (e.g., selectively connected) to a common source (SRC) 216 and can include memory cells 208₀ to 208_{N}. The memory cells 208 can represent non-volatile memory cells for storage of data. The memory cells 208 of each NAND string 206 can be connected in series between a select transistor 210 (e.g., a field-effect transistor), such as one of the select gates 210₀ to 210_{M} (e.g., that can be source select transistors, commonly referred to as select gate source), and a select transistor 212 (e.g., a field-effect transistor), such as one of the select transistors 212₀ to 212_{M} (e.g., that can be drain select transistors, commonly referred to as select gate drain). Select gates 210₀ to 210_{M} can be commonly connected to a select line 214, such as a source select line (SGS), and select gates 212₀ to 212_{M} can be commonly connected to a select line 215, such as a drain select line (SGD). Although depicted as traditional field-effect transistors, the select transistors 210 and 212 can utilize a structure similar to (e.g., the same as) the memory cells 208. The select transistors 210 and 212 can represent a number of select gates connected in series, with each select transistor in series configured to receive a same or independent control signal.

A source of each select transistor 210 can be connected to common source 216. The drain of each select transistor 210 can be connected to a memory cell 208₀ of the corresponding NAND string 206. For example, the drain of select gate 210₀ can be connected to memory cell 208₀ of the corresponding NAND string 206₀. Therefore, each select transistor 210 can be configured to selectively connect a corresponding NAND string 206 to the common source 216. A control gate of each select transistor 210 can be connected to select line 214.

The drain of each select transistor 212 can be connected to bit line 204 for the corresponding NAND string 206. For example, the drain of select gate 212₀ can be connected to the bit line 204₀ for the corresponding NAND string 206₀. The source of each select transistor 212 can be connected to a memory cell 208_{N} of the corresponding NAND string 206. For example, the source of select gate 212₀ can be connected to memory cell 208_{N} of the corresponding NAND string 206₀. Therefore, each select transistor 212 can be configured to selectively connect a corresponding NAND string 206 to the corresponding bit line 204. A control gate of each select transistor 212 can be connected to select line 215.

The memory array 200A in FIG. 2A can be a quasi-two-dimensional memory array and can have a generally planar structure, e.g., where the common source 216, NAND strings 206 and bit lines 204 extend in substantially parallel planes. Alternatively, the memory array 200A in FIG. 2A can be a three-dimensional memory array, e.g., where NAND strings 206 can extend substantially perpendicular to a plane containing the common source 216 and to a plane containing the bit lines 204 that can be substantially parallel to the plane containing the common source 216.

Typical construction of memory cells 208 includes a data-storage structure 234 (e.g., a floating gate, charge trap, and the like) that can determine a data state of the memory cell (e.g., through changes in threshold voltage), and a control gate 236, as shown in FIG. 2A. The data-storage structure 234 can include both conductive and dielectric structures while the control gate 236 is generally formed of one or more conductive materials. In some cases, memory cells 208 can further have a defined source/drain (e.g., source) 230 and a defined source/drain (e.g., drain) 232. Memory cells 208 have their control gates 236 connected to (and in some cases form) a word line 202.

A column of the memory cells 208 can be a NAND string 206 or a number of NAND strings 206 selectively connected to a given bit line 204. A row of memory cells 208 can be memory cells 208 commonly connected to a given word line 202. A row of memory cells 208 can, but need not, include all the memory cells 208 commonly connected to a given word line 202. Rows of memory cells 208 can often be divided into one or more groups of physical pages of memory cells 208, and physical pages of the memory cells 208 often include every other memory cell 208 commonly connected to a given word line 202. For example, the memory cells 208 commonly connected to word line 202_{N} and selectively connected to even bit lines 204 (e.g., bit lines 204₀, 204₂, 204₄, etc.) can be one physical page of the memory cells 208 (e.g., even memory cells) while memory cells 208 commonly connected to word line 202_{N} and selectively connected to odd bit lines 204 (e.g., bit lines 204₁, 204₃, 204₅, etc.) can be another physical page of the memory cells 208 (e.g., odd memory cells).

Although bit lines 204₃-204₅ are not explicitly depicted in FIG. 2A, it is apparent from the figure that the bit lines 204 of the array of memory cells 200A can be numbered consecutively from bit line 204₀ to bit line 204_{M}. Other groupings of memory cells 208 commonly connected to a given word line 202 can also define a physical page of memory cells 208. For certain memory devices, all memory cells commonly connected to a given word line can be deemed a physical page of memory cells. The portion of a physical page of memory cells (which, in some embodiments, could still be the entire row) that is read during a single read operation or programmed during a single programming operation (e.g., an upper or lower page of memory cells) can be deemed a logical page of memory cells. A block of memory cells can include those memory cells that are configured to be erased together, such as all memory cells connected to word lines 202₀-202_{N} (e.g., all NAND strings 206 sharing common word lines 202). Unless expressly distinguished, a reference to a page of memory cells herein refers to the memory cells of a logical page of memory cells. A logical page may or may not be the same as a physical page. Although the example of FIG. 2A is discussed in conjunction with NAND flash, the embodiments and concepts described herein are not limited to a particular array architecture or structure, and can include other structures (e.g., SONOS, phase change, ferroelectric, etc.) and other architectures (e.g., AND arrays, NOR arrays, etc.).

FIG. 2B is another schematic of a portion of an array of memory cells 200B as could be used in a memory device 130, e.g., as a portion of the array of memory cells 104. Like numbered elements in FIG. 2B correspond to the description as provided with respect to FIG. 2A. FIG. 2B provides additional detail of one example of a three-dimensional NAND memory array structure. Three-dimensional NAND memory array 200B can incorporate vertical structures which can include semiconductor pillars where a portion of a pillar can act as a channel region of the memory cells of NAND strings 206. NAND strings 206 can be each selectively connected to a bit line 204₀-204_{M} by a select transistor 212 (e.g., that can be drain select transistors, commonly referred to as select gate drain) and to a common source 216 by a select transistor 210 (e.g., that can be source select transistors, commonly referred to as select gate source). Multiple NAND strings 206 can be selectively connected to the same bit line 204. Subsets of NAND strings 206 can be connected to their respective bit lines 204 by biasing the select lines 215₀-215_{K} to selectively activate particular select transistors 212 each between a NAND string 206 and a bit line 204. The select transistors 210 can be activated by biasing the select line 214. In some embodiments, each sub-block or string of memory cells has a separate select line 214 from other sub-blocks or strings. In some embodiments, a pair of sub-blocks shares a select line 214. Each word line 202 can be connected to multiple rows of memory cells of the memory array 200B. Rows of memory cells that are commonly connected to each other by a particular word line 202 can collectively be referred to as tiers.

The three-dimensional NAND memory array 200B may include multiple stacked layers of levels of memory cells and connected using vertical channels such as semiconductor pillars. The number of layers in three-dimensional NAND memory array 200B can be, for example, 32, 48, 64, 96, 112 layers, or any number of layers. In some examples, a group of layers may be collectively referred to as a deck. A deck in a three-dimensional NAND memory array may be processed together (e.g., etched together for forming a portion of the semiconductor pillar). A memory device having three-dimensional NAND memory arrays can provide more memory cells on a single chip than a memory device formed by two-dimensional NAND arrays; and therefore provide a higher storage capacity. Furthermore, in a memory device having three-dimensional NAND memory arrays, transistors in memory cells are spaced out, and therefore interference and electron leaks can be reduced.

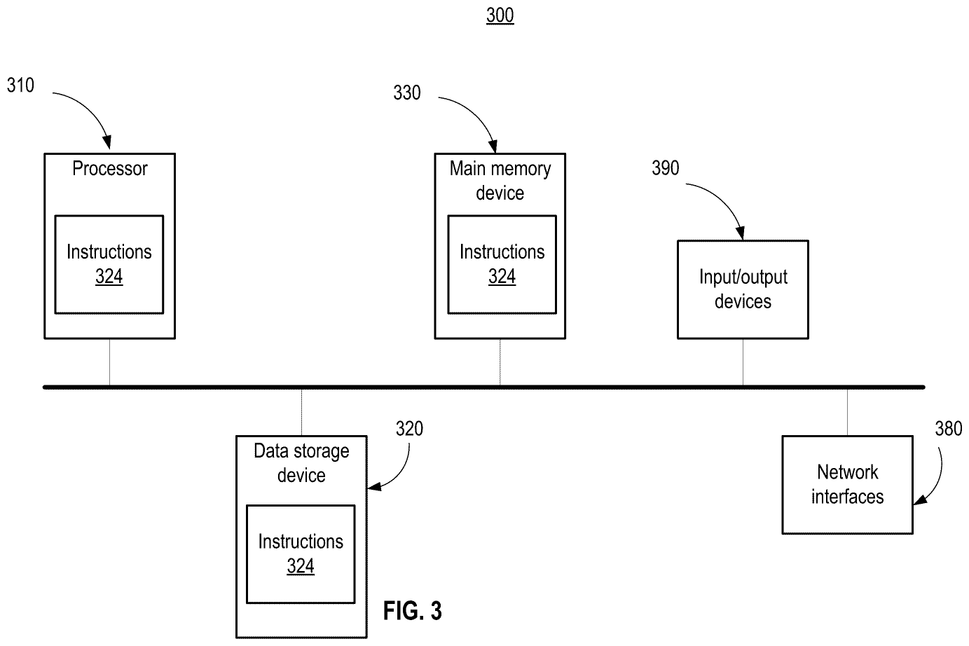

A high-level block diagram of an example apparatus 300 that may be used to implement systems, apparatus, and methods described herein is illustrated in FIG. 3. It is understood that various systems, apparatus, and methods described herein may be implemented using analog and/or digital circuitry, or using one or more computers using well-known computer processors, memory systems, storage devices, computer software, and other components. Typically, a computer includes a processor for executing instructions and one or more memory systems for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of at least some of the FIGS. 1-7, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

As shown in FIG. 3, apparatus 300 may be used to implement a host system that includes, is coupled to, or utilizes a memory system. Apparatus 300 can be used to perform operations of a controller (e.g., to execute an operating system to perform operations corresponding to system controller 115 and/or local controller 135 of FIG. 1).

In some embodiments, apparatus 300 comprises a processor 310 operatively coupled to a data storage device 320 and a main memory device 330. Processor 310 controls the overall operation of apparatus 300 by executing computer program instructions 324 that define such operations. The instructions 324 include instructions to implement functionality of a controller (e.g., system controller 115 and/or local controller 135 of FIG. 1). The computer program instructions 324 may be stored in data storage device 320, or other computer-readable medium, and loaded into main memory device 330 when execution of the computer program instructions is desired. For example, processor 310 may be used to implement one or more components and systems described herein, such as system controller 115 and/or local controller 135 (shown in FIG. 1). Thus, the method steps of at least some of FIGS. 1-7 can be defined by the computer program instructions 324 stored in main memory device 330 and/or data storage device 320 and controlled by processor 310 executing the computer program instructions 324. For example, the computer program instructions 324 can be implemented as computer executable code programmed by one skilled in the art to perform an algorithm defined by the method steps discussed herein in connection with at least some of FIGS. 1-7. Accordingly, by executing the computer program instructions, processor 310 executes an algorithm defined by the method steps of these aforementioned figures to perform operations (e.g., read, program, erase, etc.). Apparatus 300 also includes one or more network interfaces 380 for communicating with other devices via a network. Apparatus 300 may also include one or more input/output devices 390 that enable user interaction with apparatus 300 (e.g., display, keyboard, mouse, speakers, buttons, etc.).

Processor 310 may include both general and special purpose microprocessors and may be the sole processor or one of multiple processors of apparatus 300. Processor 310 may comprise one or more central processing units (CPUs), and one or more graphics processing units (GPUs), which, for example, may work separately from and/or multi-task with one or more CPUs to accelerate processing, e.g., for various image processing applications described herein. Processor 310, data storage device 320, and/or main memory device 330 may include, be supplemented by, or incorporated in, one or more application-specific integrated circuits (ASICs) and/or one or more field programmable gate arrays (FPGAs).

Data storage device 320 and main memory device 330 each comprise a tangible non-transitory computer readable storage medium. Data storage device 320, and main memory device 330, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices (NAND memory devices, NOR memory devices), semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices. For example, data storage device 320 may be implemented using a memory system described herein. In some examples, data storage device 320 and main memory device 330 may include one or more memory devices 130 (FIG. 1).

Input/output devices 390 may include peripherals, such as a printer, scanner, display screen, etc. For example, input/output devices 390 may include a display device such as a cathode ray tube (CRT), plasma or liquid crystal display (LCD) monitor for displaying information to a user, a keyboard, and a pointing device such as a mouse or a trackball by which the user can provide input to apparatus 300.

Any or all of the functions of the systems and apparatuses discussed herein may be performed by processor 310, and/or incorporated in, an apparatus or a system such as system 100. Further, system 100 and/or apparatus 300 may utilize one or more neural networks or other deep-learning techniques performed by processor 310 or other systems or apparatuses discussed herein.

One skilled in the art will recognize that an implementation of an actual computer or computer system may have other structures and may contain other components as well, and that FIG. 3 is a high-level representation of some of the components of such a computer for illustrative purposes.

FIG. 4A illustrates a prior art device 400 capable of replacing data in a read-only memory (ROM). As illustrated in FIG. 4A, memory device 400 includes an array of memory cells 404, a ROM 420, a controller 435, a replacement memory 410, and a page buffer 452. It is understood that device 400 shown in FIG. 4A is simplified and may thus include other components not shown. The ROM 420 of device 400 stores read-only data such as executable codes for performing device initialization, read, program, erase, and other operations. Typically, the codes for performing a device initialization are stored in the most upfront address section 422 of ROM 420, such that they are executed first after power up and reset. The process is shown in process 440 of FIG. 4B. In process 440, upon powering up (block 442) of the memory device 400, the controller 435 receives (block 444) a reset command (e.g., an FFh command) and resets the memory device 400. After the memory device 400 resets, the controller 435 executes the initialization codes (block 446) stored in the most upfront section of ROM 420.

As shown in FIG. 4A, ROM 420 includes other address sections in addition to the most upfront address section 422. For example, if section 422 is the first address section, ROM 420 may include a second address section 423 for storing the code for loading replacement data from a replacement memory (REM), a third address section 424 for storing read algorithm codes, a fourth address section 426 for storing program algorithm codes, a fifth address section 427 for storing erase algorithm codes, and a sixth address section 428 for storing codes for other algorithms. These address sections 422, 423, 424, 426, 427, and 428 may be consecutive address sections as shown in FIG. 4A.

As described above, ROM 420 stores read-only data. Therefore, codes stored in the various address sections in ROM 420 cannot be changed or rewritten like a regular read/write memory block (e.g., memory blocks in the array of memory cells 404). As such, if the read-only data stored in ROM 420 has an error (e.g., a software bug in any of the codes for performing device initialization, read, program, erase, or other algorithms) or if there are new versions of the codes available, ROM 420 cannot be easily rewritten. Existing technologies to address this problem may use a replacement memory (REM) 410.

Replacement memory 410 may be volatile memories like SRAM (static random access memory). REM 410 may be a separate and distinct memory from the array of memory cells 404 and ROM 420. Replacement memory 410 may have a size of, e.g., 10-20% of the size of the ROM 420. Therefore, if the ROM 420 has a size of 16 KB (Kilo Byte), the REM 410 may have a size of 1.6 KB.

If the read-only data stored at particular address sections of ROM 420 need to be changed or updated, the manufacturer can use the controller 435 to load the replacement data to the array of memory cells 404 before shipping to the customer. The controller 435 can then control page buffer 452 to read the replacement data from the array of memory cells 404 during the initialization process shown in FIG. 4B. The page buffer 452 stores the replacement data in its latches or registers. The controller 435 may then load the replacement data from the page buffer 452 to the REM 410. The controller 435 can perform these operations (e.g., loading from array 404 to page buffer 452, loading from page buffer 452 to REM 410) by executing the initialization codes stored in the address section 422/423 of the ROM 420. FIG. 4A further illustrates an address section 421 storing a part of the initialization code.

After controller 435 executes the initialization codes stored in ROM address section 422, it executes the codes in the next ROM address section, which is section 423. ROM address section 423 stores codes for loading the replacement memory data from the REM 410 to controller 435. With reference to FIG. 4A, REM 410 stores replacement data, which include the ROM addresses and corresponding replacement codes. For example, REM 410 may store the replacement codes for ROM address A and ROM address B. Thus, instead of executing codes stored at ROM addresses A and B, controller 435 executes the replacement codes stored in REM 410. ROM addresses A and B can be addresses in any of sections 421, 424, 426, 427, and 428 for storing read algorithm codes, program algorithm codes, erase algorithm codes, and other algorithm codes, respectively.

There are several problems with the existing technologies. As shown in FIG. 4A, the codes for loading the replacement memory data are stored at ROM address section 423, which is located after the ROM address section 422. In other words, the codes for loading the replacement memory data (stored in ROM address section 423) can only be executed after the execution of the initialization codes (stored in ROM address section 422). As a result, if the initialization codes have errors (e.g., software bugs), they cannot be replaced by using the replacement data stored in REM 410, because the initialization codes (including the erroneous codes) would have been already executed before the controller 435 could execute the codes for loading the replacement memory data. Thus, if the initialization codes have errors, the memory device may be un-usable and may need to be discarded or recalled (if the device has been shipped to the customer).

The existing technology has other drawbacks of low efficiency, cumbersome, and time consuming. Specifically, for loading the replacement data to REM 410, controller 435 needs to store the replacement data in the array of memory cells 404 (e.g., a NAND array), cause the page buffer 452 to read the data from the array of memory cells 404 into page buffer 452, and then transfer the data from page buffer 452 to REM 410. Thus, the whole process is quite cumbersome and time consuming. Furthermore, if the read-only data stored in the ROM 420 and/or replacement data stored in REM 410 have errors, the memory system may need to enter into a system debug mode. In the system debug mode, controller 435 may need to reload the entire replacement data stored in REM 410, not just the part that has errors. As described above, the REM 410 may have a size of 10-20% of the size of the ROM 420. As such, reloading the replacement data of the entire REM 410 may involve moving a large amount of data, which can be very time consuming and cumbersome. For example, the reloading of the entire REM 410 may involve moving more than 1.6 KB data in the system debug mode.

Moreover, moving data through page buffer 452 may add another layer of complexity. Page buffer 452 usually requires a complex data format for enhancing data reliability since the data is coming from the array of memory cells 404. For instance, the data stored in page buffer 452 may require multiple copies of the same data for redundancy. Page buffer 452 may also store the data and the complimentary version of the data (e.g., if the data is 0011, the complimentary version is 1100). Other data formatting requirements may also be required for storing data in page buffer 452. All these requirements, while enhancing the data reliability, may reduce the efficiency and flexibility of loading the replacement data and using such data to replace the erroneous codes in the ROM 420 and/or REM 410. Further, the system debug mode may sometimes only be accessible by the device manufacture, not the customers, because special equipment may be needed to process such a large amount of data with complex data format. For instance, for security and reliability purposes, the ROM 420 and/or REM 410 may include special memory blocks reserved only for the manufacturer, but are not accessible to the customers. They may be highly reliable memory blocks that are used to store critical data for operations of the memory device.

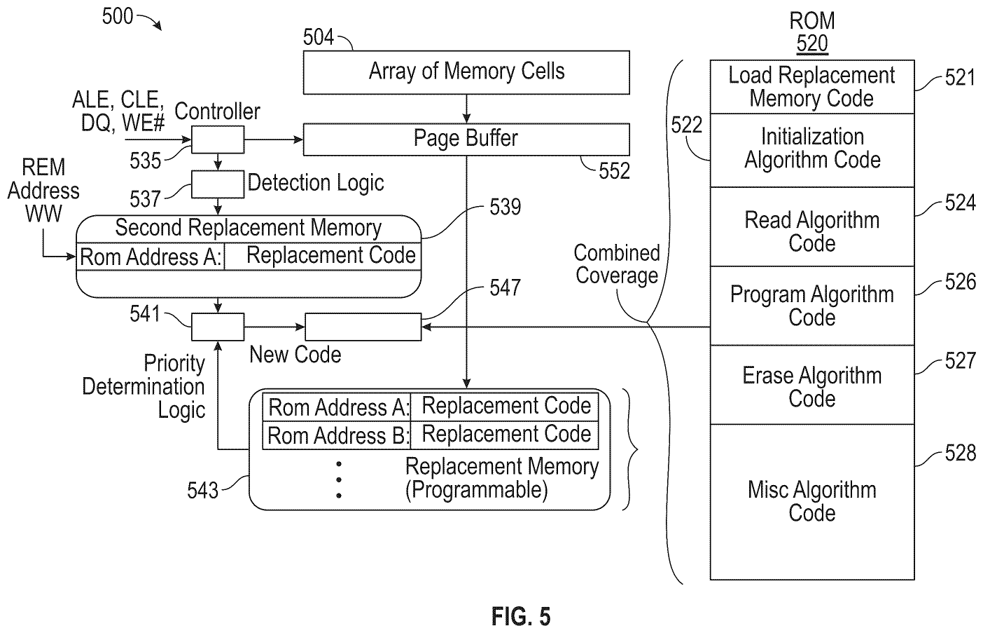

Technologies described herein can solve or mitigate the above problems, thereby enhancing the flexibility of replacing read-only data in the ROM. FIG. 5 illustrates a memory device 500 configured for improving reliability and flexibility of replacing data (e.g., codes) in a ROM, in accordance with examples as disclosed herein. Device 500 includes, for example, an array of memory cells 504, a ROM 520, a controller 535, a detection logic circuit 537, a page buffer 552, a priority determination logic circuit 541, a first REM 543 and a second REM 539. The array of memory cells 504, page buffer 552, and controller 535 can be substantially the same as array of memory cells 104, page buffer 152, and controller 135 (or controller 115), respectively, described above in connection with FIG. 1. Thus, they are not repeatedly described.

In device 500 of FIG. 5, ROM 520 is a non-volatile storage and may include a plurality of memory blocks. ROM 520 may include address sections that have similar structures as described above. As shown in FIG. 5, ROM 520 includes multiple address sections for storing read-only data including executable codes. In ROM 520, unlike ROM 420, codes for loading replacement data are stored at address section 521; which is the most upfront address section in ROM 520. Next, the initialization codes are stored at address sections 522; the read algorithm codes are stored at address section 524; the program algorithm codes are stored at address section 526; the erase algorithm codes are stored at address section 527, and other algorithm codes are stored at address section 528. It is understood that the read, program, erase, and other algorithm codes can be stored in other orders and not necessarily in the same order as shown in FIG. 5.

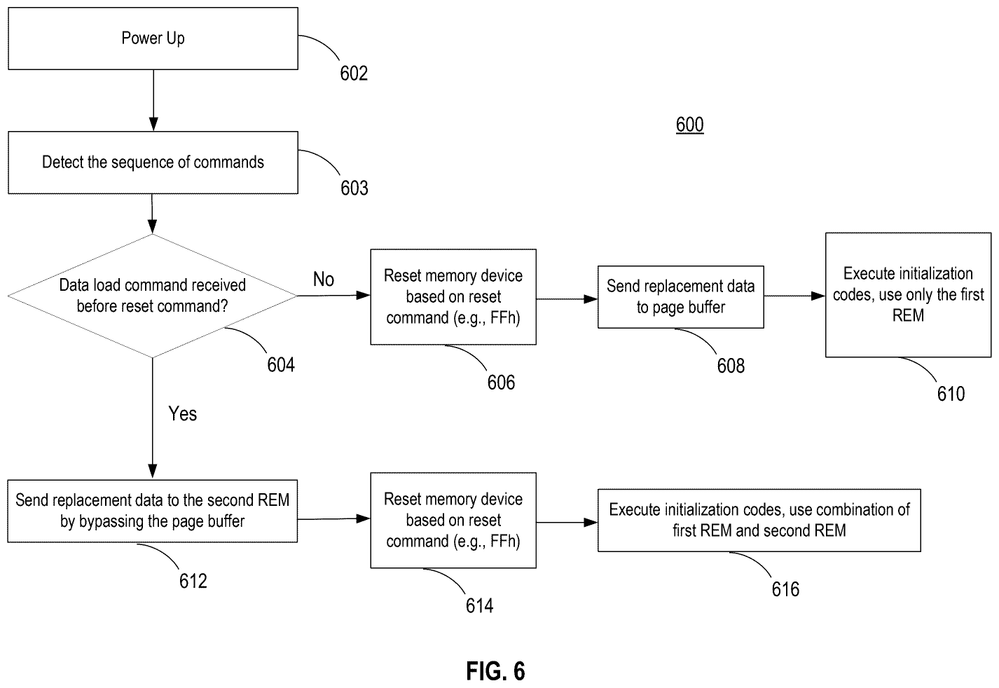

In ROM 520, codes for loading replacement memory data are stored at ROM address section 521, which is the most upfront address section in ROM 520. The initialization codes are stored at ROM address section 522, which is the next address section adjacent to address section 521. As a result, after powering up memory device 500, the controller 535 executes the codes for loading the replacement data (e.g., the codes stored in address section 521 of ROM 520). As a result of executing the codes stored in section 521, the controller 535 can load replacement data from one or both of first REM 543 and second REM 539, before it executes the initialization codes stored in address section 522 of ROM 520. This is because the codes for loading the replacement codes are stored at an ROM address section that is in front of the ROM address section for storing the initialization codes. Thus, if the initialization codes stored in section 522 of ROM 520 have errors (or if any of the other codes stored in ROM 520 have errors), replacement codes can be obtained from replacement data stored in first REM 543 and/or second REM 539. In some examples, to execute the codes for loading the replacement data (e.g., the codes stored in address section 521), controller 535 may receive a data load command before receiving a reset command. In other words, in these examples, after powering up the memory device 500, controller 535 does not first execute the reset command. Instead, it first executes the codes for loading replacement data (e.g., codes stored in address section 521). This process performed by the controller 535 after powering up the memory device 500 is described in more detail below using FIG. 6.

With reference still to FIG. 5, in some embodiments, memory device 500 includes a first REM 543 and a second REM 539. The first REM 543 is configured to store a first replacement data. The first REM 543 is accessible by the controller 535 via at least one of the array of memory cells 504 and page buffer 552. The first REM 543 may be volatile memories like SRAM. First REM 543 may be a separate and distinct memory from the array of memory cells 504 and ROM 520. First REM 543 may have a size of, e.g., 10-20% of the size of the ROM 520. Therefore, if the ROM 520 has a size of 16 KB (Kilo Byte), the first REM 543 may have a size of 1.6 KB.

If read-only data stored at certain address sections of ROM 420 need to be replaced, the controller 535 may load the first replacement data to the array of memory cells 504. The first replacement data, as shown in FIG. 5, may include one or more ROM addresses (e.g., ROM address A, ROM address B, etc.) and the replacement codes for replacing the read-only data stored at the particular ROM addresses. The controller 535 can then control page buffer 552 to read the first replacement data from the array of memory cells 504. Page buffer 552 receives and stores the first replacement data in its latches or registers. Controller 535 may then load the first replacement data from page buffer 552 to the first REM 543. Controller 535 can perform these operations (e.g., loading from memory array 504 to page buffer 552, loading from page buffer 552 to first REM 543) by executing the initialization codes stored in ROM address section 522/521 of the ROM 520.

While using the first REM 543 can replace any erroneous read-only data stored in ROM 520, it cannot be used to replace erroneous data stored in itself. Moreover, loading or updating the first replacement data may involve moving a large amount of data for the entire first REM 543, which can be time consuming and cumbersome. For example, the reloading of the entire first REM 543 may involve moving more than 16 KB data in the system debug mode. Furthermore, once the memory device is delivered to the customer, the system debug mode may not be available to the customer, and therefore, the customer may not have access to the first REM 543.

The second REM 539 shown in FIG. 5 can mitigate or eliminate the above problems. Second REM 539 is configured to store a second replacement data for replacing at least one of the read-only data stored in the ROM 520 or the first replacement data stored in the first REM 539. The second replacement data, in one example, include at least one of the following: (1) one or more particular ROM addresses in ROM 520 and the corresponding second replacement codes for replacing the read-only codes stored at the particular ROM addresses; or (2) one or more particular ROM addresses that are being replaced by first REM 543 and the corresponding second replacement codes for replacing the first replacement codes stored at the particular REM addresses in first REM 543. In other words, the second REM 539 can be used to replace data stored in one or both of ROM 520 and first REM 543. When replacing data stored in first REM 543, the first REM 543 and the second REM 539 include the same ROM addresses. As described below, a priority determination logic 541 determines that the second REM 539 has a higher priority and therefore, the controller 535 uses the replacement codes stored in the second REM 539 to replace the codes stored in ROM 520. As such, the corresponding replacement codes stored in first REM 543 are not used or effectively replaced by the replacement codes stored in second REM 539.

In some embodiments, the second REM 539 has a size that is substantially smaller than a size of the first REM 543. For example, the size of the second REM 539 may be a binary fraction of the first REM 543. Thus, if the first replacement data stored in the first REM 543 can replace read-only data stored at 128 ROM addresses, the second replacement data stored in the second REM 539 can replace data stored at, for example, 2 ROM addresses in ROM 520 (or 2 REM addresses in first REM 543). In this case, the capacity of the second REM 539 may be just 1/64 of the capacity of the first REM 543. Other sizes of the second REM 539 can also be implemented. Having a much smaller size than the first REM 543, the second REM 439 can be accessed easily and faster by the user (e.g., a customer).

With continued reference to FIG. 5, unlike accessing the first REM 543, the controller 535 is configured to access the second REM 539 while bypassing the page buffer 552 and the array of memory cells 504. As shown in FIG. 5, controller 535 is coupled to the second REM 539 via an optional detection logic circuit 537. In some examples, the detection logic circuit 537 can be a part of the controller 535. Therefore, controller 535 communicates with the second REM 539 directly without going through the page buffer 552. This is different from accessing the first REM 543. As described above, for accessing the first REM 543, controller 535 needs to move a large amount of data (e.g., 16 KB) from the array of memory cells 504 to page buffer 552, and then from page buffer 552 to first REM 543. In contrast, for accessing the second REM 539, controller 535 can directly move data into the second REM 539 while bypassing the page buffer 552 and memory array 504.

As described above, the size of the second REM 539 may be substantially smaller than the size of the first REM 543. Thus, for example, to load or update first REM 543, the controller 535 may need to load 16K data even if only a small portion (e.g., one line of code) in first REM 543 needs to be replaced or updated. However, to load or update the second REM 539, controller 535 may only need to move a small amount of data (e.g., codes for replacing two ROM addresses or two first REM addresses), depending on the size of the second REM 543. Thus, loading or updating second REM 539 may have a significant improvement of time and efficiency compared to that of the first REM 543.

In some examples, the first REM 543 is accessible by controller 535 using a first data format, and the second REM 539 is accessible by controller 535 using a second data format. The second data format can have a reduced complexity compared to the first data format. As described above, moving data through page buffer 552 may require complex data formatting. For example, page buffer 552 may require a complex data format for enhancing data reliability. For instance, the data stored in page buffer 552 may require multiple copies of the same data for redundancy. Page buffer 552 may also store the data and the complimentary version of the data (e.g., if the data is 0011, the complimentary version is 1100). Other data formatting requirements may also be required. The complex data format, while enhancing the data reliability, is also cumbersome. A user of the memory device may not be able to process data according to this complex data format absent of customized debugging equipment. The complex data format also increases the size of the data, thereby slowing down the code replacement process and reduces the overall efficiency.

Loading or updating codes into the second REM 539 does not require such complex data format, because the second replacement data are directly moved by the controller 535 to second REM 539 while bypassing the page buffer 552. Accordingly, using the second REM 539 can also improve the efficiency of the code replacement process and also allow the user to easily access the second REM 539 for replacing codes in the first REM 543 and/or ROM 520. For example, if after the memory device 500 is delivered to a customer, an erroneous code has been discovered in ROM 520 and/or first REM 543, the replacement code can be sent to the customer. The customer can program the erasable programmable read-only memory (EPROM) in a host system with the replacement code. The host system then powers up the memory device (e.g., a NAND device) and instructs controller 535 to load the replacement code to a second REM 539. The erroneous code in ROM 520 or the first REM 543 may then be replaced with the replacement code stored in second REM 539, thereby correcting the particular algorithm.

With continued reference to FIG. 5, the second REM 539 is coupled with controller 535 via a detection logic circuit 537. Detection logic circuit 537 may include any combination or configuration of digital circuits, analog circuits, or mixed signal circuits for making detections and determinations as described below. In some examples, detection logic circuit 537 is a part of controller 535. When controller 535 receives a replacement data, the replacement data may be sent to page buffer 552 or sent to the second REM 539. If the replacement data are sent to page buffer 552, controller 535 may later move the replacement data from page buffer 552 to the first REM 543. If the replacement data are sent to the second REM 539, then page buffer 552 can be bypassed. In some examples, the detection logic circuit 537 can be configured to determine whether a replacement data should be sent to page buffer 552 or sent to the second REM 539 while bypassing page buffer 552. One example of making such a determination is illustrated using a flowchart in FIG. 6.

FIG. 6 is a flowchart illustrating an initialization process 600 of a memory device (e.g., device 500), in accordance with examples as disclosed herein. With reference to both FIGS. 5 and 6, in block 602, the memory device 500 is powered up (e.g., by a host system). In block 603, a detection logic circuit 537, which may be a separate circuit or may be a part of controller 535, detects a sequence of a plurality of commands received (e.g., from a controller at the host system). In block 604, the detection logic circuit 537 determines if a data load command is received before or after a reset command (e.g., an FFh command). Typically, a reset command is issued after powering up the memory device and before the execution of the initialization codes. Receiving a data load command before the reset command can cause the replacement data to be loaded to the second REM 539. As a result, even if there are erroneous codes in the initialization algorithm codes stored in ROM 520, they can be replaced with the corrected codes stored in the second REM 539.

A data load command may have an existing command format or may have a new command format. In one example, the data load command may have the format like 80h-WWh-XXh-YYh-ZZh, where WWh represents at least an address of the second REM 539. The address of the second REM 539 refers to the location within the second REM where the data structure is stored. So in the case where the second REM 539 has a size of 2, the possible WWh values can be 1 or 2. In the above data load command, XX/YY/ZZ represent a specific address combination and can be used as a passcode. The passcode is used for security reasons, such that if a command does not include this passcode, the controller of the memory device will ignore this data load command.

In block 612, if the detection logic circuit 537 determines that the data load command is received before the reset command is received, it can cause controller 535 to send the replacement data to the second REM 539 by bypassing page buffer 552. The replacement data are thus stored in second REM 539. As described above, the second REM 539 may have a much smaller size compared to the first REM 543. Therefore, the replacement data stored in second REM 539, may have, for example, two ROM addresses or two first REM addresses, and their corresponding replacement codes.

In block 614, after the memory device 500 receives the data load command, it then receives the reset command (e.g., an FFh command). Based on this command, the controller 535 of memory device 500 can cause the memory device 500 to reset. In block 616, after the device resets, controller 535 continues to load and execute the initialization codes stored in the ROM 520, while replacing any of the erroneous codes with the replacement codes stored in the second REM 539 and/or the first REM 543.

With continued reference to FIG. 6, in block 604, if the detection logic circuit 537 determines that the data load command is received after the reset command is received, it first resets the memory device based on the reset command (e.g., FFh) at block 606. The detection logic circuit 537 may then cause controller 535 to send the replacement data to the page buffer 552 (block 608). Controller 535 can move the replacement data from page buffer 552 to first REM 543. At block 610, controller 535 executes the initialization codes and may use only the replacement data stored in the first REM 543. This is because the replacement data received are not stored in the second REM 539, and therefore, controller 535 can bypass the second REM 539 in this situation.

With reference back to FIG. 5, in some examples, the memory device 500 includes a priority determination logic circuit 541 coupled between the first REM 543 and the second REM 539. The priority determination logic circuit 541 may include any combination or configuration of digital circuits, analog circuits, or mixed signal circuits for making priority determinations as described below. Priority determination logic circuit 541 can be a standalone circuit or a part of controller 535. The priority determination logic circuit 541 is configured to determine a priority between the first replacement data stored in the first REM 543 and the second replacement data stored in the second REM 539.

As described above, the first REM 543 and the second REM 539 may each store some replacement data. For example, the first REM 543 may store first replacement data including addresses of ROM 520 and the corresponding replacement codes. The second REM 539 may store second replacement data including addresses of ROM 520 and corresponding replacement codes and/or addresses of ROM 520 that are to be replaced by first REM 543 and corresponding replacement codes. Therefore, there is a possibility that the same addresses of ROM 520 are stored in both the first REM 543 and the second REM 539. As a result, there may be conflicts and issues as to the priority of the replacement data stored in first REM 543 or the second REM 539.

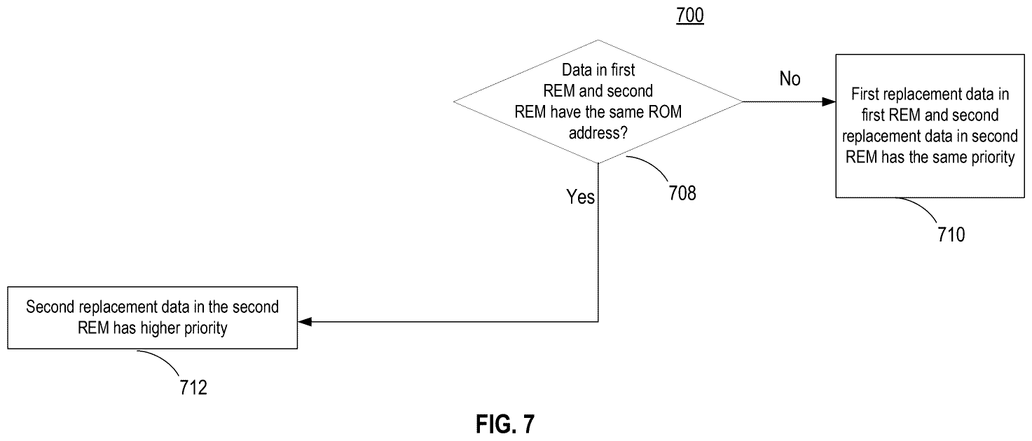

FIG. 7 illustrates one example of determining priority between the second REM 539 and first REM 543. With reference to both FIGS. 5 and 7, in some examples, the priority determination logic circuit 541 determines if the data stored in first REM 543 and second REM 539 include the same address(es) of the ROM 520. If yes, this means there is a possible conflict between the replacement codes for the same address(es) of the ROM 520. In this situation, the priority determination logic circuit 541 can determine that second replacement data stored in second REM 539 should have the higher priority. For instance, the first REM 543 may store an older version of the replacement codes, while the second REM 539 may store an updated version of the replacement codes. Thus, the second REM 539 should have a higher priority.

If at block 708, the priority determination logic circuit 541 determines that data stored in the first REM 543 and second REM 539 do not include the same address(es) in the ROM 520, this means the first replacement data and the second replacement data are complimentary, and there is no conflict between the first REM 543 and second REM 539. As a result, the priority determination logic circuit 541 may determine (block 710) that the first replacement data and the second replacement data have the same priority (or it may determine that it is not necessary to make a priority determination). It is understood that the priority determination logic circuit 541 can be configured in other ways to make desired priority determinations. If the memory device 500 has more than two REMs (e.g., a first REM, a second REM, and a third REM), the priority determination logic circuit 541 can be configured correspondingly to make more complex priority determinations.

With reference back to FIG. 5, in some examples, the memory device 500 may include a register 547. The register 547 can be coupled to both the priority determination logic circuit 541 and ROM 520. The priority determination logic circuit 541, after determining the priority between the first REM 543 and second REM 539, outputs the replacement data having a higher priority or the same priority (e.g., first replacement data from first REM 543 or second replacement data from second REM 539, or both) to the register 547. The register 547 also may receive read-only data from ROM 520 if no replacement is needed for any particular ROM addresses. The codes stored in register 547 can be executed by controller 535 to perform various operations of the memory device 500. Thus, if codes in a ROM address needs to be replaced, the controller 535 executes replacement codes stored in register 547, if not, the controller 535 executes codes stored in ROM 520.

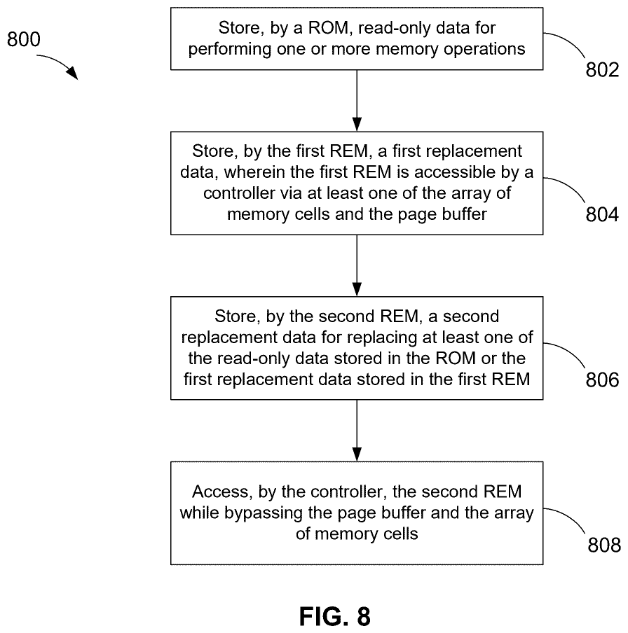

FIG. 8 is a flowchart illustrating a process 800 performed by a memory device (e.g., memory device 500) comprising an array of memory cells (e.g., array 504), a page buffer (e.g., page buffer 552), a controller (e.g., controller 535), a read-only memory (e.g., ROM 520), a first REM (e.g., REM 543), and a second REM (e.g., REM 539). The process 800 begins with a block 802, in which the controller causes storing read-only data for performing one or more memory operations in the ROM. At block 804, the controller causes the storing a first replacement data in the first REM, wherein the first REM is accessible by the controller via at least one of the array of memory cells and the page buffer. At block 806, the controller causes storing a second replacement data in the second REM. The second replacement data are for replacing at least one of the read-only data stored in the ROM or the first replacement data stored in the first REM. At block 808, the controller accesses the second REM while bypassing the page buffer and the array of memory cells.

It should be noted that the described techniques include possible implementations, and that the operations and the blocks may be rearranged, reordered, or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor (e.g., processor 310 of FIG. 3), the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory device comprising:
an array of memory cells;
a page buffer;
a controller;
a read-only memory (ROM) configured to store read-only data for performing one or more memory operations;
a first replacement memory (REM) configured store a first replacement data, wherein the first REM is accessible by the controller via at least one of the array of memory cells and the page buffer; and
a second REM configured to store a second replacement data for replacing at least one of the read-only data stored in the ROM or the first replacement data stored in the first REM,
wherein the controller is configured to access the second REM while bypassing the page buffer and the array of memory cells.

2. The memory device of claim 1, wherein the second REM has a size that is substantially smaller than a size of the first REM.

3. The memory device of claim 1, wherein the first REM is accessible by the controller using a first data format, and the second REM is accessible by the controller using a second data format, the second data format having reduced complexity compared to the first data format.

4. The memory device of claim 1, wherein the read-only data include a load-REM code as a part of initialization codes; and wherein the ROM is configured to store the load-REM code in an order such that the load-REM code is executed before execution of other parts of the initialization codes.

5. The memory device of claim 4, wherein the read-only data stored in the ROM further include one or more of: a read algorithm code, a program algorithm code, an erase algorithm code, and other algorithm codes.

6. The memory device of claim 1, further comprising:
a detection logic circuit coupled to the second REM, the detection logic circuit being coupled to the controller or being a part of the controller, wherein the detection logic circuit is configured to perform:
determining whether a replacement data should be sent to the page buffer or sent to the second REM by bypassing the page buffer;
in accordance with a determination that replacement data should be sent to the page buffer, directing the replacement data to the page buffer; and
in accordance with a determination that replacement data should be sent to the second REM, directing the replacement data to the second REM and bypassing the page buffer.

7. The memory device of claim 6, wherein determining whether the replacement data should be sent to the page buffer or sent to the second REM comprising:
detecting a sequence of a plurality of commands; and
determining, based on the detected sequence of the plurality of commands, whether the replacement data should be sent to the page buffer or the second REM.

8. The memory device of claim 7, wherein determining, based on the detected sequence of the plurality of commands, whether the replacement data should be sent to the page buffer or the second REM comprises:
if a data load command is detected to be received before receiving a reset command, determining that the replacement data should be sent to the second REM by bypassing the page buffer; and
if the data load command is detected to be received after receiving the reset command, determining that the replacement data should be sent to the page buffer.

9. The memory device of claim 8, wherein the data load command comprises:
at least an address of the second REM; and
a combination representing a passcode.

10. The memory device of claim 1, further comprising:
a priority determination logic circuit coupled to the second REM, wherein the priority determination logic circuit is configured to perform determining a priority between the first replacement data stored in the first REM and the second replacement data stored in the second REM.

11. The memory device of claim 10, wherein determining the priority between the first replacement data stored in the first REM and the second replacement data stored in the second REM comprises:
determining whether the second replacement data stored in the second REM comprises an address in the first REM;
in accordance with a determination that the second replacement data stored in the second REM comprises an address in the first REM, determining that the second replacement data stored in the second REM has a higher priority.

12. The memory device of claim 11, further comprising:
in accordance with a determination that the second replacement data stored in the second REM does not comprise an address in the first REM,
determining that the first replacement data and the second replacement data have the same priority (e.g., this is the case where a change in ROM code is required, so the priority is the same. And the small REM and large REM data are combined); or
determining that the second replacement data has a higher priority if the first replacement data and the second replacement data comprise a same address in the ROM.

13. The memory device of claim 1, further comprising a register coupled to the second REM, the register being configured to store the first replacement data or the second replacement data, whichever has a higher priority.

14. The memory device of claim 13, wherein the controller is configured to execute a code stored in the register in lieu of a corresponding code stored in the ROM.

15. A memory system comprising:
a processor; and
a memory device coupled to the processor, the memory device comprising:
an array of memory cells;
a page buffer;
a controller;
a read-only memory (ROM) configured to store read-only data for performing one or more memory operations;
a first replacement memory (REM) configured store a first replacement data, wherein the first REM is accessible by the controller via at least one of the array of memory cells and the page buffer; and
a second REM configured to store a second replacement data for replacing at least one of the read-only data stored in the ROM or the first replacement data stored in the first REM,
wherein the controller is configured to access the second REM while bypassing the page buffer and the array of memory cells.

16. A method performed by a memory device comprising an array of memory cells, a page buffer, a controller, a read-only memory (ROM), a first replacement memory (REM), and a second REM, the method comprising:
storing, in the ROM, read-only data for performing one or more memory operations;
storing, in the first REM, a first replacement data, wherein the first REM is accessible by the controller via at least one of the array of memory cells and the page buffer; and;
storing, in the second REM, a second replacement data for replacing at least one of the read-only data stored in the ROM or the first replacement data stored in the first REM; and
accessing, by the controller, the second REM while bypassing the page buffer and the array of memory cells.

17. The method of claim 16, wherein the second REM has a size that is substantially smaller than a size of the first REM.

18. The method of claim 16, wherein the first REM is accessible by the controller using a first data format, and the second REM is accessible by the controller using a second data format, the second data format having reduced complexity compared to the first data format.

19. The method of claim 16, wherein the read-only data include a load-REM code as a part of initialization codes; and wherein the ROM is configured to store the load-REM code in an order such that the load-REM code is executed before execution of other parts of the initialization codes.

20. The method of claim 19, wherein the read-only data stored in the ROM include one or more of: a read algorithm code, a program algorithm code, an erase algorithm code, and other algorithm codes.

21. The method of claim 20, further comprising:
performing, by a detection logic circuit coupled to the second REM:
determining whether a replacement data should be sent to the page buffer or sent to the second REM by bypassing the page buffer;
in accordance with a determination that replacement data should be sent to the page buffer, directing the replacement data to the page buffer; and
in accordance with a determination that replacement data should be sent to the second REM, directing the replacement data to the second REM and bypassing the page buffer.

22. The method of claim 21, wherein determining whether the replacement data should be sent to the page buffer or sent to the second REM comprising:
detecting a sequence of a plurality of commands; and
determining, based on the detected sequence of the plurality of commands, whether the replacement data should be sent to the page buffer or the second REM.

23. The method of claim 22, wherein determining, based on the detected sequence of the plurality of commands, whether the replacement data should be sent to the page buffer or the second REM comprises:
if a data load command is detected to be received before receiving a reset command, determining that the replacement data should be sent to the second REM by bypassing the page buffer; and
if the data load command is detected to be received after receiving the reset command, determining that the replacement data should be sent to the page buffer.

24. The method of claim 16, further comprising:
determining, by a priority determination logic circuit coupled to the second REM, a priority between the first replacement data stored in the first REM and the second replacement data stored in the second REM.

25. The method of claim 24, wherein determining the priority between the first replacement data stored in the first REM and the second replacement data stored in the second REM comprises:
determining whether the second replacement data stored in the second REM comprises an address in the first REM;
in accordance with a determination that the second replacement data stored in the second REM comprises an address in the first REM, determining that the second replacement data stored in the second REM has a higher priority.
